(19) United States
(12) Patent Application Publication
(10) Pub. No.: US 2025/0368458 A1
(43) Pub. Date: Dec. 4, 2025

(54) RECEIVING ASSEMBLY AND ITS USE, AND METHOD AND SYSTEM FOR LOADING A TANK

(71) Applicant: DYNAMIC AIR LTDA, São Paulo (BR)

(72) Inventors: HORACIO N. PAEZ, São Paulo (BR); GREGORY J. STEELE, St. Paul, MN (US)

(73) Assignee: DYNAMIC AIR LTDA, São Paulo (BR)

(21) Appl. No.: 19/221,145

(22) Filed: May 28, 2025

(30) Foreign Application Priority Data
Jun. 4, 2024 (BR) 10 2024 011160 5

(51) Int. Cl. B65G 65/32

(52) U.S. Cl. CPC B65G 65/32

(57) ABSTRACT

The present invention relates to a receiving assembly for particles of material to be loaded into a tank, the assembly comprising: a receiving equipment configured to receive and store the particles of material; at least one gas injection device connected to the receiving equipment; and at least one valve configured to open and close at least one outlet of the receiving equipment, wherein the at least one gas injection device is configured to generate a gas flow that passes through at least one valve while it is open. The present invention also relates to the use of the receiving assembly in loading tanks, to a method of loading tanks and to a system comprising the receiving assembly.

### TECHNICAL FIELD

The present invention is related to the field of material handling and transportation. In particular, the present invention is related to a receiving assembly for particles of material used to load or feed a tank.

### BACKGROUND ART

Tanks are commonly used for the storage and transportation of products in general. Depending on the application, tanks, usually made of metal or composite material, can assume, for example, the role of silos, reactors and pneumatic conveyors.

For loading a tank, such as a silo or a pneumatic conveyor, a receiving equipment, known as a hopper in the industry, is used. It is responsible for receiving and temporarily storing particles of material to be loaded into the tank. The flow of these particles from the receiving equipment to the interior of the tank is usually regulated by one or more valves positioned between the outlet of the receiving equipment and the inlet of the tank. Over time, and especially when abrasive particles are handled, the wear caused by friction between these particles and the parts of the valve exposed to the flow of particles reduces the useful life of the valve, which must be replaced at some point.

To mitigate this problem, it is common to use valves made of resistant materials. However, these valves are expensive. Therefore, alternative and/or complementary solutions are desired.

### SUMMARY OF THE INVENTION

The present invention relates to a receiving assembly for particles of material to be loaded into a tank, the assembly comprising: a receiving equipment configured to receive and store the particles of material; at least one gas injection device connected to the receiving equipment; and at least one valve configured to open and close at least one outlet of the receiving equipment, wherein the at least one gas injection device is configured to generate a gas flow that passes through at least one valve while it is open.

Optionally, the receiving equipment has an inverted cone shape.

Optionally, the receiving equipment additionally comprises at least one extension in its lower part, wherein a valve is installed at the outlet of each extension and at least one gas injection device is installed in each extension.

Optionally, the gas is air.

Optionally, the tank is a pneumatic conveyor.

The present invention also relates to the use of the receiving assembly as described above for loading particles of material into a tank.

The present invention also relates to a system for loading particles of material into a tank comprising the receiving assembly as described above and the tank.

The present invention also relates to a method for loading particles of material into a tank by means of the receiving assembly as described above, the method comprising the steps of: receiving the particles of material into the receiving equipment; opening at least one valve; and actuating at least one gas injection device to generate a gas flow that passes through at least one open valve.

### BRIEF DESCRIPTION OF THE DRAWINGS

FIG. 1 illustrates an example of loading a tank as known in the prior art.

FIG. 2 illustrates an example of a receiving assembly according to a first embodiment of the present invention.

FIG. 3 illustrates an example of a receiving assembly according to a second embodiment of the present invention.

FIG. 4 illustrates an example of a gas injection device that can be used in the receiving assembly according to the present invention.

FIGS. 5 and 6 illustrate an example of a valve that can be used in the receiving assembly according to the present invention.

### DETAILED DESCRIPTION

The technology of pneumatic material conveyance is widely known in the state of the art. It is based on the use of a flow of air or other gas to move material from one location to another. Pneumatic conveyance is widely used in several industries, such as food, pharmaceutical and chemical ones, as it is an efficient, safe and clean form of transport. Pneumatic conveyance generally involves a system composed of a network of pipes, valves, air pumps or compressors, tanks and pneumatic conveyors. The materials to be transported are loaded into a pneumatic conveyor which is typically responsible for pushing the material from its interior into a pipe through a gas stream. Depending on the application, pneumatic conveyance can be carried out in two main ways: dilute or dense phase.

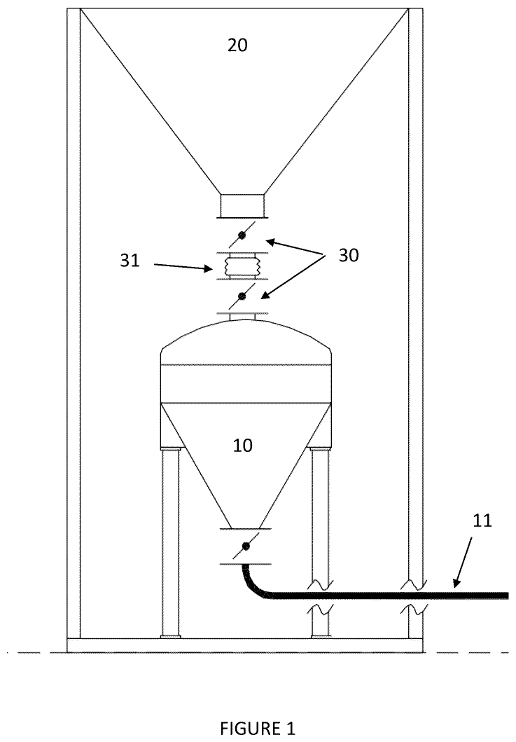

FIG. 1 illustrates a schematic example as known in the state of the art of loading a tank 10, which, in this example, is presented in the form of a pneumatic conveyor. As can be seen in FIG. 1, a receiving equipment 20, such as a hopper, is mounted on a skid above tank 10. Two valves 30 separate the outlet of the receiving equipment 20 and the inlet of tank 10 from an extension tube 31. The extension tube 31 is essentially a section of piping, typically metallic, that connects the receiving equipment 20 to the tank 10. Valves 30 are controlled to open and close the fluidic path between the outlet of the receiving equipment 20 and the inlet of tank 10, passing through the extension tube 31.

As can be noted by a one skilled in the art, it would be possible to use only one valve 30 to open and close the internal path between the receiving equipment 20 and the tank 10. Likewise, it would be possible to directly connect the receiving equipment 20 to the tank 10, without the presence of the extension tube 31. Furthermore, any type of valve 30 known in the state of the art that is capable of opening and closing the path between the receiving equipment 20 and the tank 10 can be used.

To perform the pneumatic conveyance, particles of material to be transported are initially discharged into the receiving equipment 20 that temporarily stores them. At some point, the valves 30 are opened allowing the particles to move, by gravity, into the pneumatic conveyor 10. When the pneumatic conveyor reaches a certain particle loading level, its inlet is closed, its lower outlet is opened, and pneumatic conveyance occurs by pushing the particles through a pipe 11.

As previously mentioned, the constant passage of particles through valves 30 and the friction generated between the particles and the parts of the valves that come into contact with the particles wear the valves 30 leading to a reduction in their useful life. This problem can be mitigated by forming one or more layers of gas between the exposed parts of the valves 30 and the particles flow path.

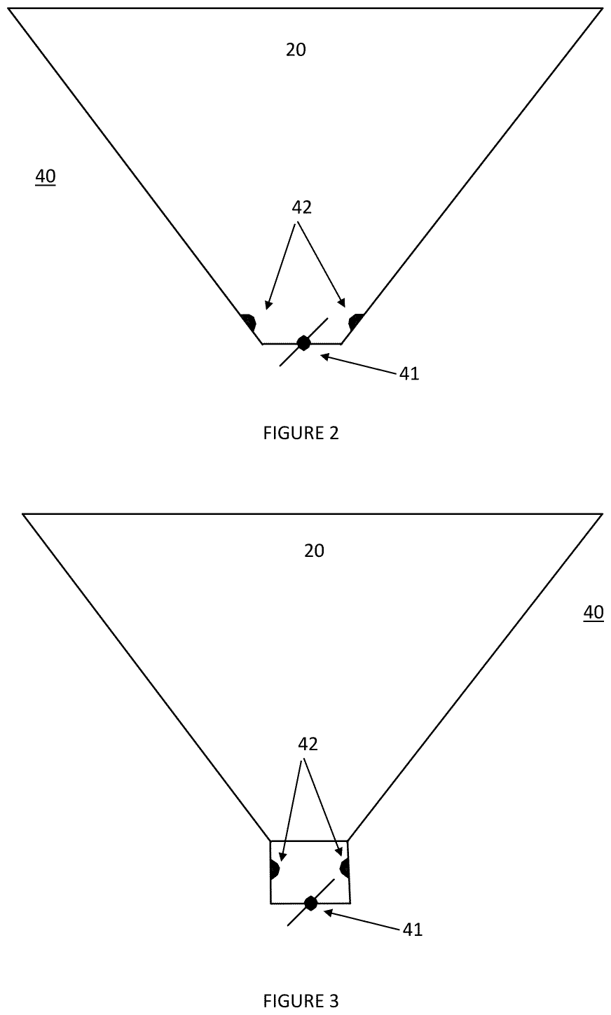

FIG. 2 illustrates a receiving assembly 40 according to the present invention in a first exemplary embodiment. The receiving assembly 40 comprises a receiving equipment 20, gas injection devices 42 and a valve 41. The receiving equipment 20 has an upper inlet for receiving particles of material to be loaded into a tank 10 and a lower outlet for directing the particles of material into the interior of the tank 10. In this exemplary embodiment, valve 41 is positioned at the lower outlet of the receiving equipment 20 and is capable of opening and closing it.

The receiving equipment 20 may be manufactured from any material that is minimally rigid to temporarily maintain the particles of material in its interior. Preferably, the receiving equipment 20 is metallic. Additionally, the receiving equipment 20 illustrated in the embodiment of FIG. 2 has the preferred shape of an inverted cone. However, as a person skilled in the art will notice, any other shape capable of receiving and directing the received particles of material into a tank 10 may be used. Examples include prismatic shapes that taper at their bottom toward the outlet.

A person skilled in the art will also notice that the receiving equipment 20 may have more than one lower outlet in the case of loading more than one tank 10. In this situation, the receiving assembly 40 may comprise more than one valve 41.

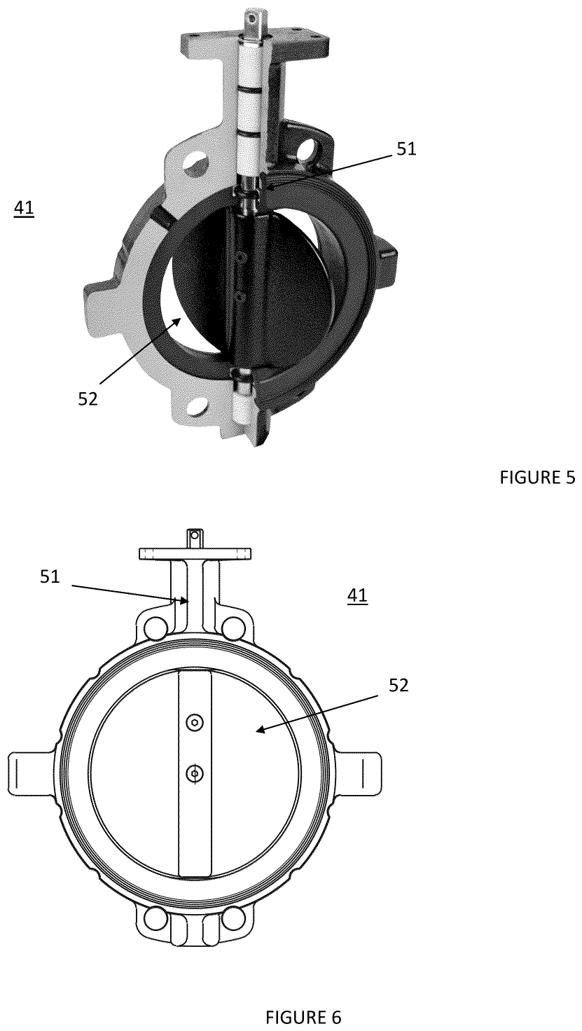

Also as mentioned previously, any opening and closing valve 41 known in the state of the art may be used. FIGS. 5 and 6 illustrate an example of a butterfly valve (posi-flate® valve manufactured and marketed by Dynamic Air Ltda). Essentially, a shaft 51 is controlled to rotate a disc 52. In the open position, disc 52 is held at an angle of approximately 90° in relation to the valve. To close the valve, disc 52 is rotated until it reaches an internal seat (not illustrated) positioned on the internal walls of the valve, being held at an angle of approximately 0° in relation to the valve.

The receiving assembly 40 according to the present invention also comprises at least one gas injection device 42 connected to the wall of the receiving equipment 20. The device is capable of generating a gas flow in the vicinity of valve 41, so that no particle or a smaller part of the particles leaving the receiving equipment 20, when valve 41 opens and/or remains open, come into contact with the exposed parts of the valve 41. The gas injection device 42 can be activated, for example, as soon as a valve 41 is opened to allow the passage of particles of material out of the receiving equipment 20.

Preferably, the gas is air.

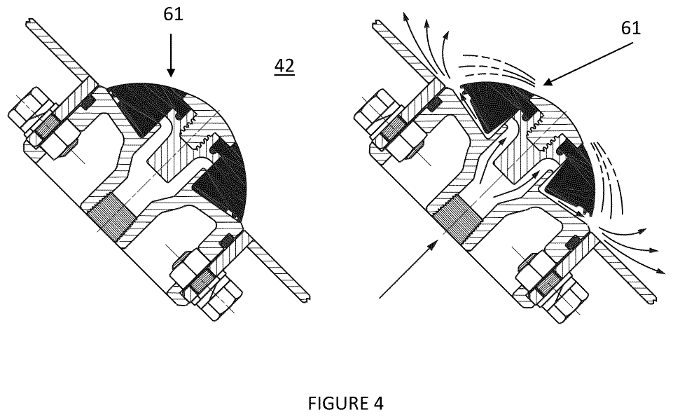

FIG. 4 illustrates an example of a gas injection device 42 (vibra-jet® injector manufactured and marketed by the company Dynamic Air Ltda.). In this device, the gas inserted follows the direction of the arrows. As can be seen, a gas flow more parallel to the surface where the injector is installed is obtained.

As a person skilled in the art will notice, other types of gas injectors can be used. For example, an injector similar to that of FIG. 4 is cited, but with a rigid and flat upper part 61, and not vibrating as the one illustrated. Or even a simple tubular gas injector, with the gas outlet bent so as to provide a flow parallel to the surface where it is installed.

FIG. 3 illustrates a receiving assembly 40 according to the present invention in a second exemplary embodiment. This second embodiment uses the same elements as the first exemplary embodiment, except for the arrangement of the valve 41 and the gas injection devices 42. The receiving equipment 20 has a tubular extension at the end of the inverted cone. The tubular extension can preferably be an integral part of the cone. On the walls of the extension, the gas injection devices 42 are installed. And valve 41 is installed at the outlet of the extension. The presence of the extension has the advantages of providing a better connection of the receiving assembly 40 to a tank 10 to be loaded and of providing a gas flow more parallel to the internal walls of the valve 41 exposed to the flow of particles. It should also be noted that multiple configurations for the receiving equipment 20 are possible. The receiving equipment 20 may, for example, have multiple outlets and multiple extensions—which is particularly useful depending on the number of tanks 10 to be loaded. Likewise, valves 41 may be installed at each outlet to regulate its opening and closing. Alternatively, a single valve 41 may regulate the opening and closing of multiple outlets.

Alternative embodiments are also possible. For example, the gas injection device 42 may be designed not to provide a parallel gas flow, but to provide a gas flow directly to the valve 41 regardless of its point of installation. A tubular gas injection device may be used for this purpose, with the piping being designed to carry the gas to the position of interest.

As one skilled in the art will appreciate, the number of gas injection devices 42 may vary from one to as many as necessary depending, for example: on the number of outlets and valves of the receiving assembly 20; on the type of gas flow (e.g., directional or more diffuse flows) provided by the gas injection device; and on how many parts of a valve 41 must be protected. For example, in the case of a tubular outlet of the receiving assembly 20, a number of four diametrically opposed gas injection devices 42 may be considered.

Thus, the receiving assembly 40 of the present invention may replace the receiving equipment 20, as used in FIG. 1, for loading tanks 10. Referring to the same example described in relation to FIG. 1, particles of material to be loaded into a tank 10 are initially discharged into the receiving assembly 40 which temporarily stores them. At some point, a valve 41 is opened allowing the particles to move, by gravity, into the interior of tank 10. The gas injection devices 42 are actuated, at least while valve 41 is opened, to provide a flow of gas through the valve 41, eliminating or reducing the contact of exposed parts of the valve 41 with the particles of material.

1. A receiving assembly for particles of material to be loaded into a tank, the receiving assembly comprising:
a receiving equipment configured to receive and store the particles of material;
at least one gas injection device connected to the receiving equipment; and
at least one valve configured to open and close at least one outlet of the receiving equipment,
wherein the at least one gas injection device is configured to generate a gas flow that passes through at least one valve while it is open.

2. The receiving assembly of claim 1, wherein the receiving equipment has an inverted cone shape.

3. The receiving assembly of claim 1, additionally comprising at least one extension in its lower part, in which a valve is installed at the outlet of each extension and at least one gas injection device is installed in each extension.

4. The receiving assembly according of claim 1, wherein the gas is air.

5. The receiving assembly according claim 1, wherein the tank is a pneumatic conveyor.

6. An use of the receiving assembly of claim 1 for loading particles of material into a tank.

7. A system for loading particles of material into a tank, the system comprising the receiving assembly of claim 1 and the tank.

8. A method of loading particles of material into a tank by means of the receiving assembly of claim 1, the method comprising the steps of:
receiving the particles of material in the receiving equipment;
opening at least one valve; and
actuating the at least one gas injection device to generate a gas flow that passes through at least one opened valve.
